(19) United States
(12) Patent Application Publication
(10) Pub. No.: US 2017/0095381 A1
(43) Pub. Date: Apr. 6, 2017

(54) MODULAR WHEELCHAIR SYSTEM

(71) Applicants: Erich C. Griffith, Warsaw, IN (US); Jason L. Ward, Warsaw, IN (US)

(72) Inventors: Erich C. Griffith, Warsaw, IN (US); Jason L. Ward, Warsaw, IN (US)

(21) Appl. No.: 15/287,290

(22) Filed: Oct. 6, 2016

Related U.S. Application Data
(60) Provisional application No. 62/237,658, filed on Oct. 6, 2015.

(51) Int. Cl. A61G 5/00; A61G 5/10; A61G 5/12; A61G 5/08; A47C 17/16

(52) U.S. Cl. CPC A61G 5/006; A61G 5/0883; A61G 5/0875; A47C 17/163; A61G 5/128; A61G 5/1067; A61G 2200/32; A61G 2200/34

(57) ABSTRACT

A convertible transport system including a seat portion and a wheeled portion that is couplable to the seat portion. The seat portion is reclinable whether or not coupled to the wheeled portion.

### CROSS REFERENCE TO RELATED APPLICATIONS

This is a non-provisional application based upon U.S. provisional patent application Ser. No. 62/237,658, entitled “MODULAR WHEELCHAIR SYSTEM”, filed Oct. 6, 2015, which is incorporated herein by reference.

### BACKGROUND OF THE INVENTION

1. Field of the Invention

The present invention relates to wheelchairs, and, more particularly, to wheelchairs that are adaptable to other healthcare uses.

2. Description of the Related Art

Wheelchairs typically incorporate a seat, foot rests and four wheels. There are usually two caster wheels at the front and two large wheels at the back of the chair. The two larger wheels in the back usually have hand rims that have a diameter normally only slightly smaller than the wheels they are attached to, and are present to allow the occupant to grasp and propel the chair. Most wheelchairs also have two handles at the top of the back to allow for manual propulsion of the chair by another person.

Other wheelchairs are variations on this basic design, but they can be customized to meet the user's needs. Seat dimensions, height of the chair, seat angle, footrests, leg rests, front caster outriggers and adjustable backrests are all items that can be customized. Additionally, propulsion and control systems can be added to allow mobility to those that have limited use of their arms.

Wheelchairs come in two major designs—folding or rigid. The rigid chairs have permanently welded joints and fewer moving parts than folding chairs. This reduces the energy required to propel the chair by eliminating many flex points whereat the chair would flex as it moves. Welding the connections, rather than making them joints also reduces the overall weight of the chair. Even though they may be considered to be a rigid chair they typically feature instant-release rear wheels and backrests that fold down flat, allowing the user to dismantle the chair quickly for storage and transport in a car.

Many rigid models are made with lightweight materials such as aircraft aluminum and titanium. Rigid chair design can also have polymer shock absorbers, such as Frog Legs, which cushion the bumps over which the chair rolls. The shock absorbers may be added to the front wheels or to the rear wheels, or both. Rigid chairs also have the option for their rear wheels to have a camber. Wheels can have a camber, or tilt, which angles the tops of the wheels in toward the chair. This allows for better propulsion by the user which is desired by long-term users. Sport wheelchairs have large camber angles to improve stability.

Various optional accessories are available, such as anti-tip bars or wheels, safety belts, adjustable backrests, tilt and/or recline features, extra support for limbs or neck, mounts or carrying devices for crutches, walkers or oxygen tanks, drink holders, and clothing protectors.

Transport wheelchairs are usually light, folding chairs that are designed to be pushed by a caregiver to provide mobility for patients outside the home or common medical settings.

Variations in wheelchair construct include tilt wheelchairs that have seating surfaces which can be tilted to various angles. A standing wheelchair is one that supports the user in a nearly standing position. They can be used as both a wheelchair and a standing frame, allowing the user to sit or stand in the wheelchair as they wish. They often go from sitting to standing with a hydraulic pump or electric-powered assist. Bariatric wheelchairs are designed to support larger weights, since most standard chairs are designed to support no more than 250 lb. Pediatric wheelchairs are another available subset of wheelchairs. Hemi wheelchairs have lower seats which are designed for easy foot propulsion.

There are various mechanisms and caregiver techniques that are used to transition a person to/from a wheelchair. Each puts the person at the risk for injury.

What is needed in the art is a wheelchair system that reduces the risk of injury as the wheelchair is adapted for other uses.

### SUMMARY OF THE INVENTION

The present invention provides a wheelchair system that converts to other transport configurations.

The invention in one form is directed to a convertible transport system including a seat portion and a wheeled portion that is couplable to the seat portion. The seat portion is reclinable whether or not coupled to the wheeled portion.

An advantage of the present invention is that a patient can be repositioned from a sitting position in a chair to a reclining position in a bed, without being removed from the frame and cushions of the chair.

Another advantage is that a patient can be prepositioned on the mechanism in a bed and the mechanism can be lifted and reconfigured to the sitting position of a chair.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an embodiment of a wheelchair of the present invention;

FIG. 2 is a view of the wheelchair of FIG. 1 in a reclined orientation;

FIG. 3 is a view of the wheelchair of FIGS. 1 and 2 with a lift coupled thereto:

FIG. 4 is a view of the wheelchair of FIGS. 1-3 where the lift has separated the chair portion from the wheel portion;

FIG. 5 is a view of the wheelchair of FIGS. 1-4 where the chair portion is being positioned to be coupled to a gurney type arrangement;

FIG. 6 is another view of the wheelchair of FIGS. 1-5 where the chair portion is being positioned to be coupled to a gurney type arrangement;

FIG. 7 is yet another view of the wheelchair of FIGS. 1-6 where the chair portion is being coupled to a gurney type arrangement;

FIG. 8 illustrates the wheelchair of FIGS. 1-7 with a person in the seat portion and the wheel portion is separated below the seat portion;

FIG. 9 illustrates a foot section of the wheelchair system of FIGS. 1-8;

FIG. 10 is another illustration of the wheelchair system of FIGS. 1-9;

FIG. 11 is yet another illustration of elements of the wheelchair system of FIGS. 1-10;

FIG. 12 is still yet another illustration of elements of the wheelchair system of FIGS. 1-11;

FIG. 13 is a closer look at the hinge assemblies used on the wheelchair system of FIGS. 1-12;

FIG. 14 is another close look at the hinge assembly of FIG. 13 used on the wheelchair system of FIGS. 1-12;

FIG. 15 is another close look at the hinge assembly of FIGS. 13 and 14 used on the wheelchair system of FIGS. 1-12;

FIG. 16 is yet another close look at the hinge assembly of FIGS. 13-15 used on the wheelchair system of FIGS. 1-12; and

FIG. 17 is yet still another close look at the hinge assembly of FIGS. 13-16 used on the wheelchair system of FIGS. 1-12.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

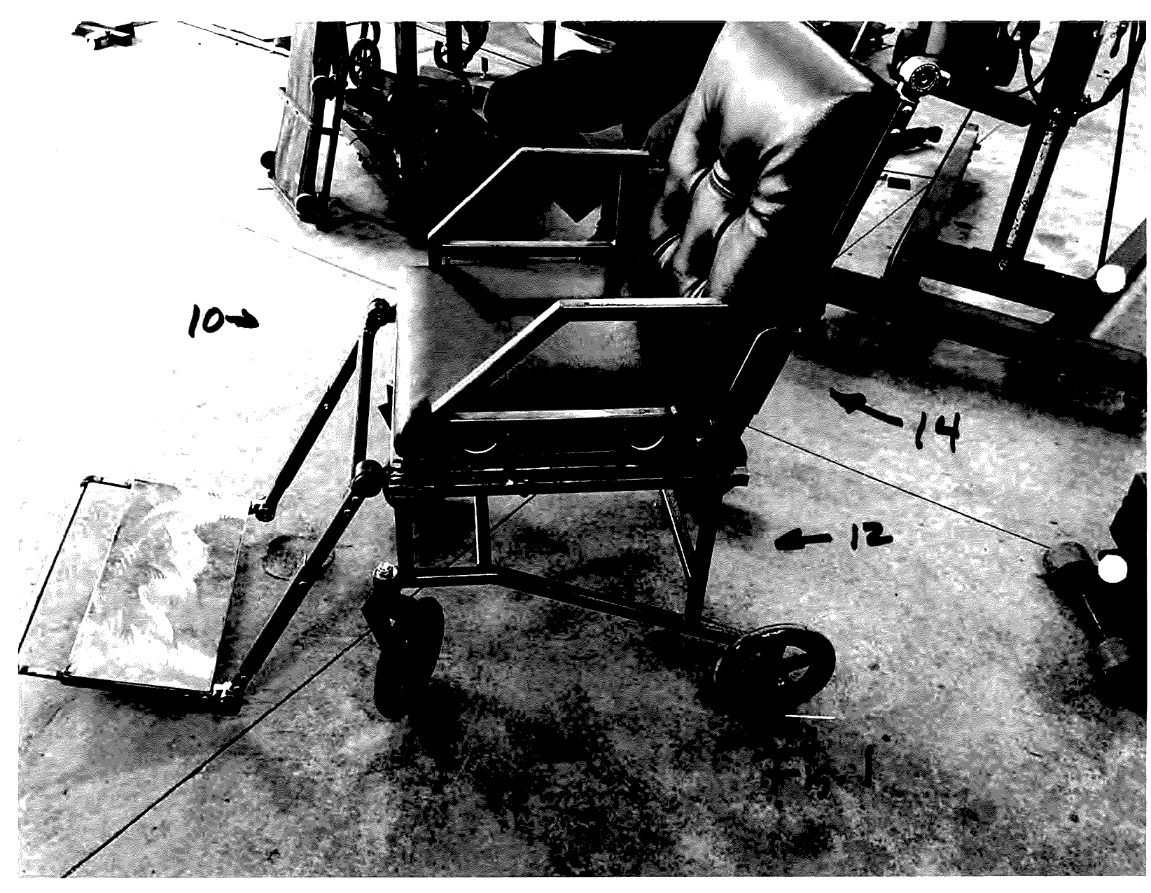

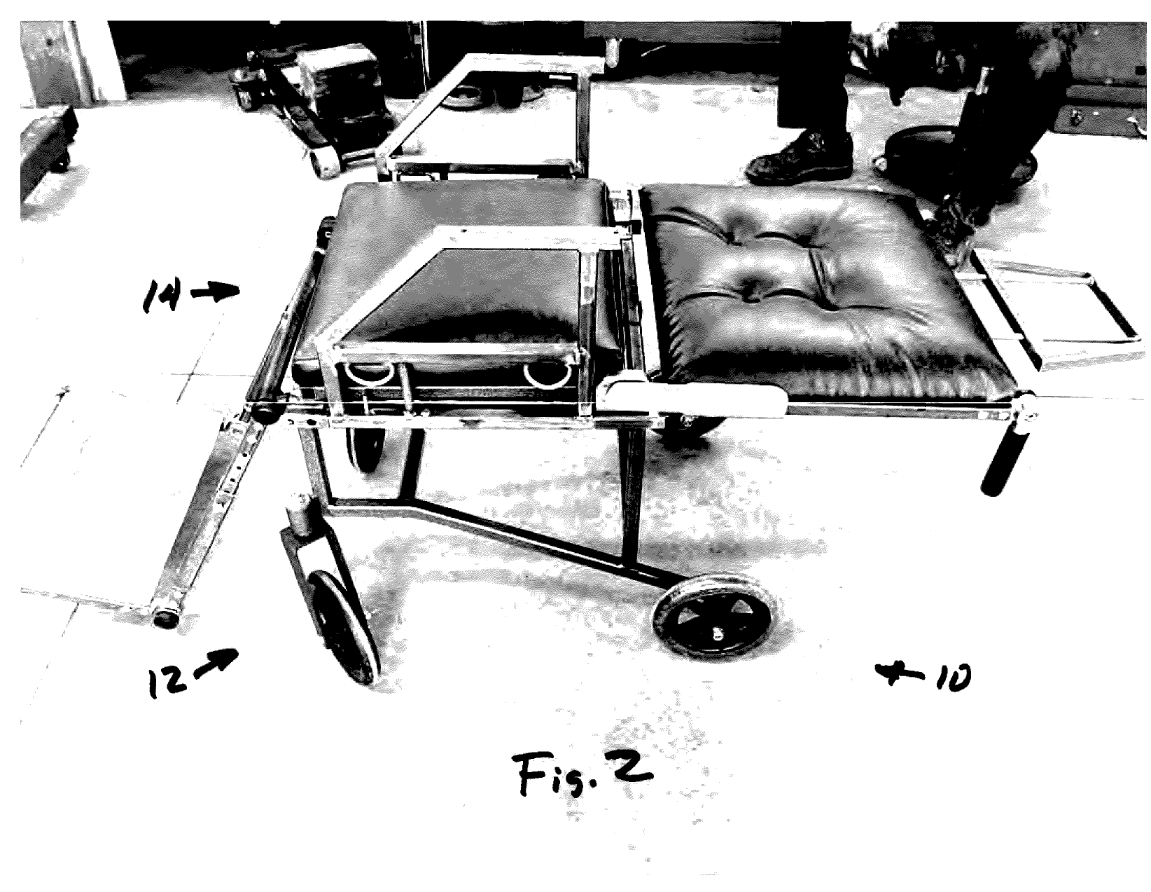

Referring now to the drawings, and more particularly to FIGS. 1-8, there is shown a modular wheel chair system 10 having a wheeled base unit 12 and a detachable chair section 14. As can be seen in FIGS. 1 and 2 chair section 14 is reclinable.

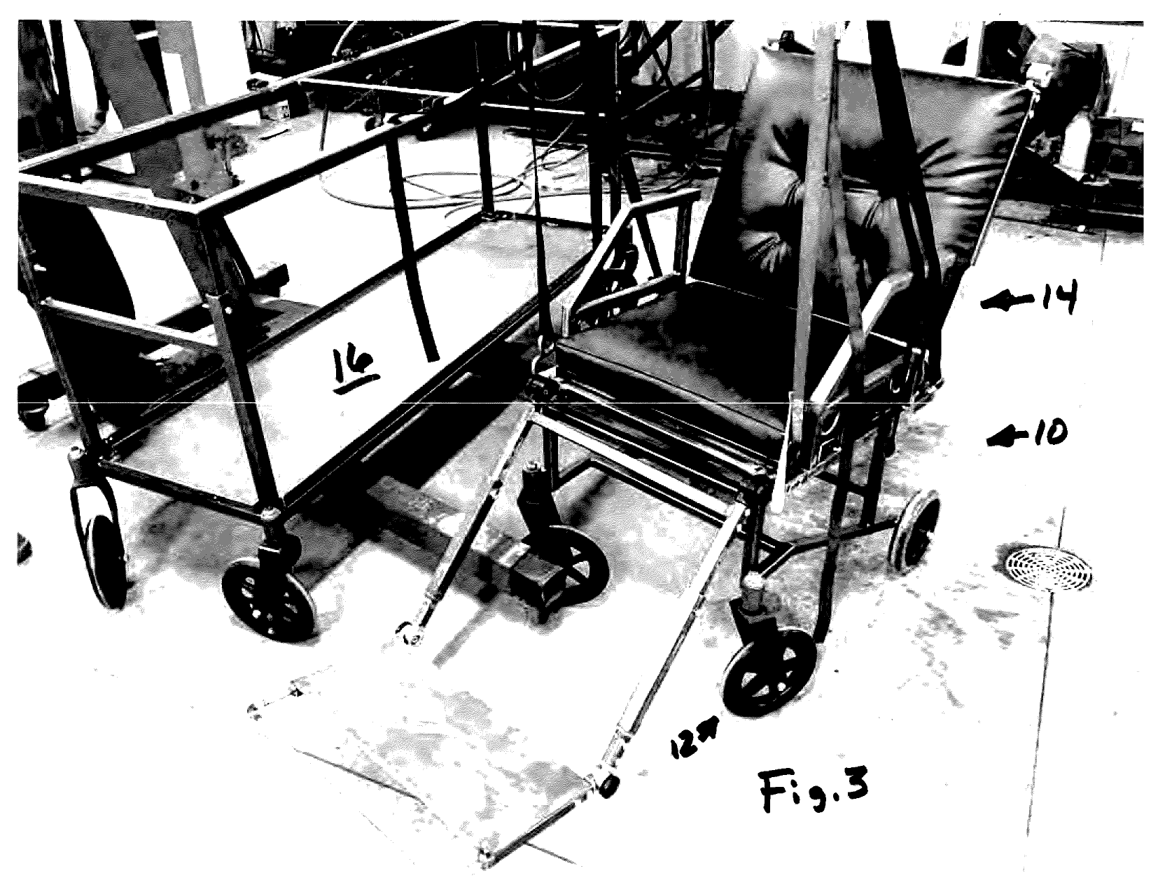

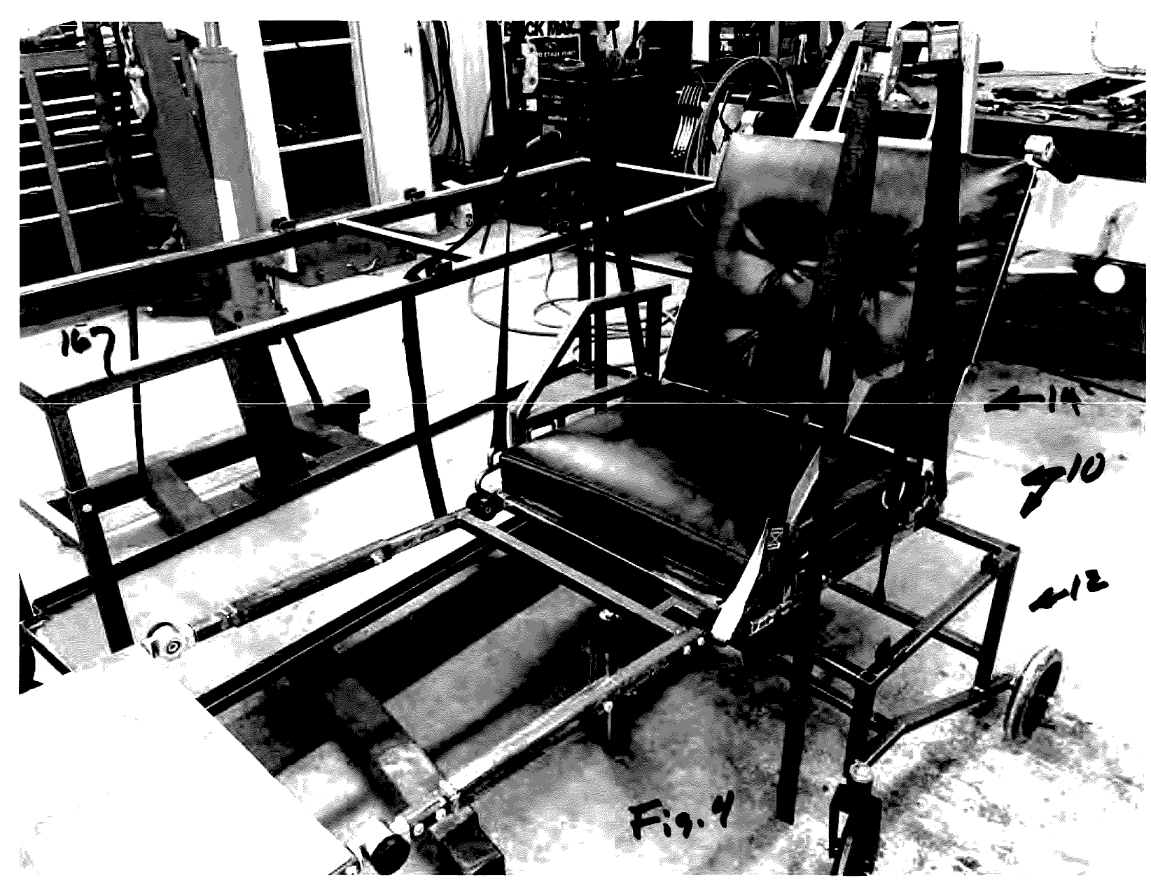

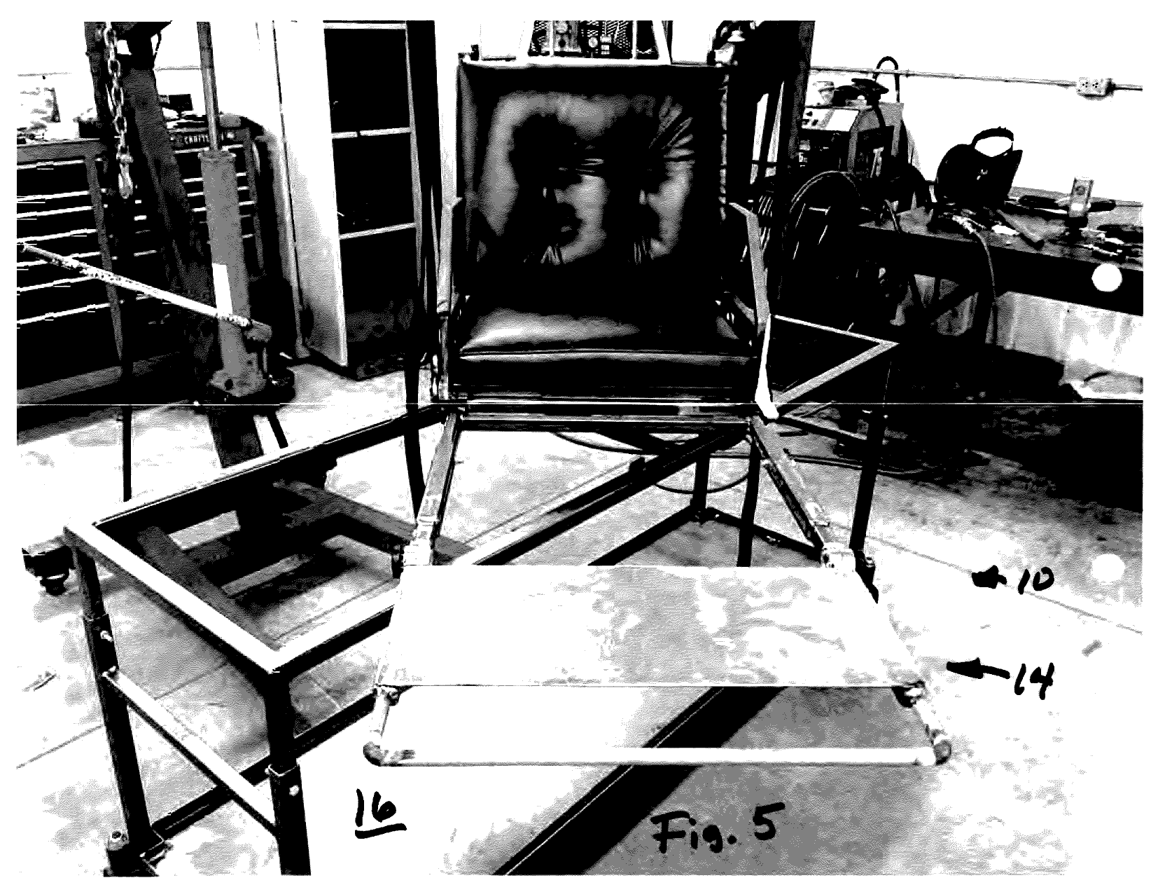

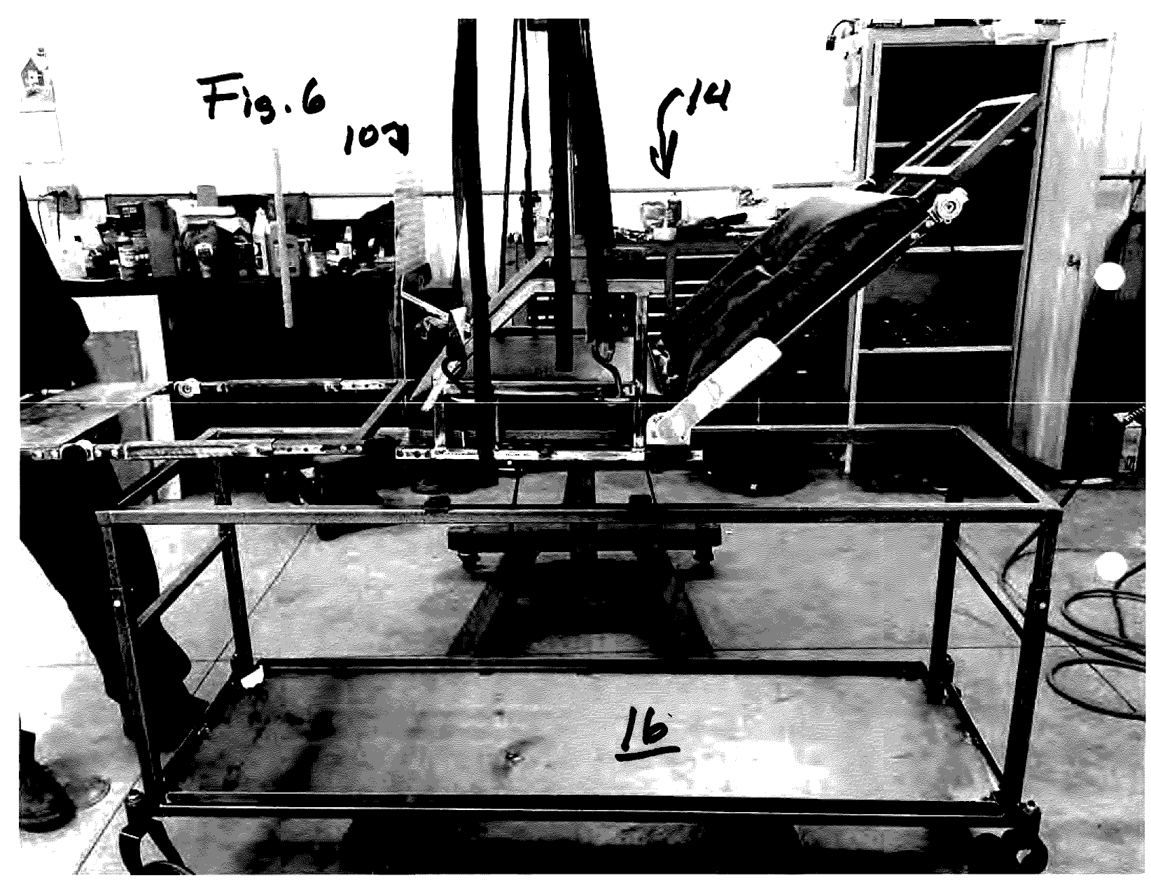

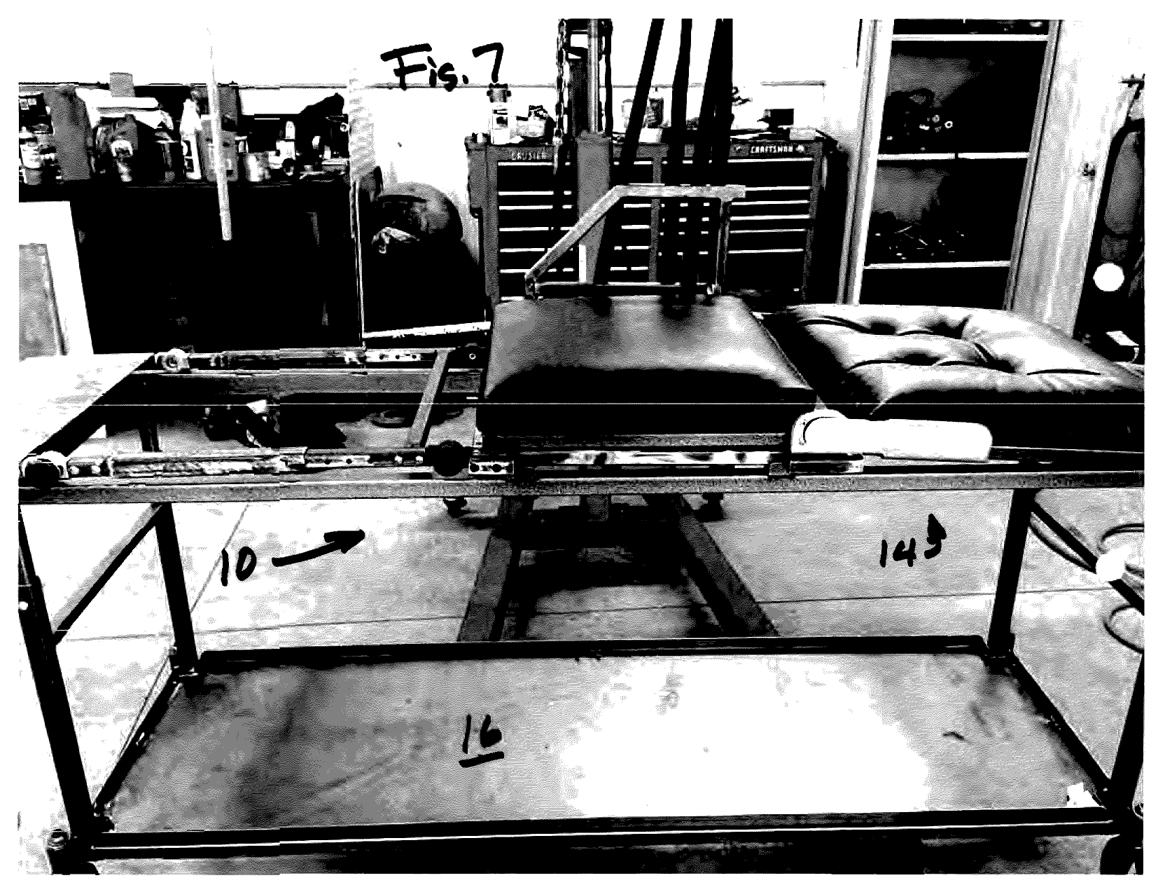

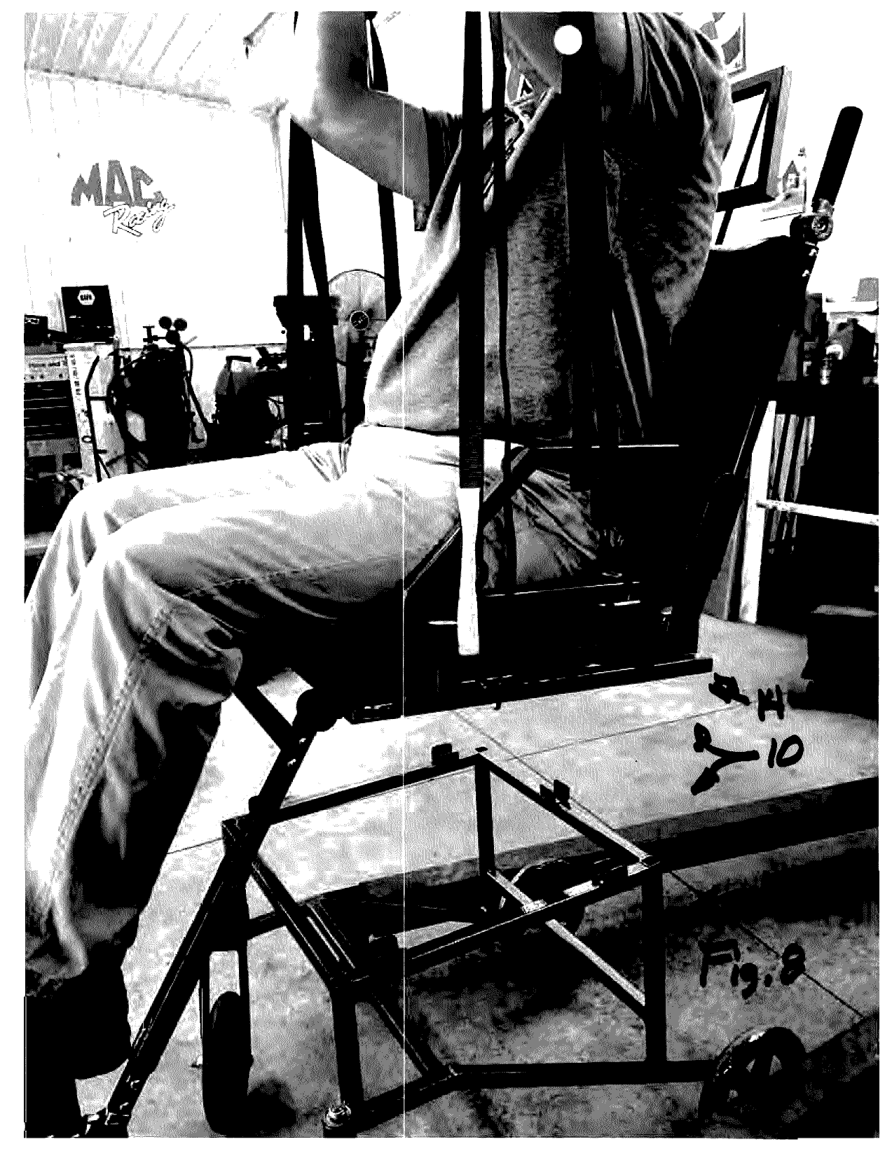

In FIGS. 3 and 4 chair section 14 is lifted from base unit 12 or wheeled portion 12 and as can be seen in FIGS. 5 and 6 elevated to a support device 16 illustrated here as a gurney (or bed) 16. In FIG. 7 chair section 14 is coupled to gurney 16 for further transport. FIG. 8 shows another view of the separation of chair section 14 from base unit 12 with a patient sitting in chair section 14.

The Modular Wheelchair System 10 is a wheelchair system designed around the acts of daily living of an individual with paralysis. The system 10 minimizes the lifting required by the care giver while simplifying the transportation of the patient. The system revolves around the wheel chairs modular flexible design. The patient remains seated in the chair 14 while it disconnects from the chair base 12. The chair 14 is then lifted to the bed 16 or to a scale or shower or a toilet and received by another base assembly (not shown but having an interface similar to 12).

In the case of the bed 16 the patient is placed into position in the bed 16, the chair 14 is let out to the horizontal position and the patient is gently rolled to the side and the chair 14 is removed and place back onto its base 12.

When the patient is ready to be moved from bed 16 the process is simply reversed.

In a hospital setting the chair 14 can be let out to the recumbent position where it can be locked, and the patient may be lifted directly to the gurney 16.

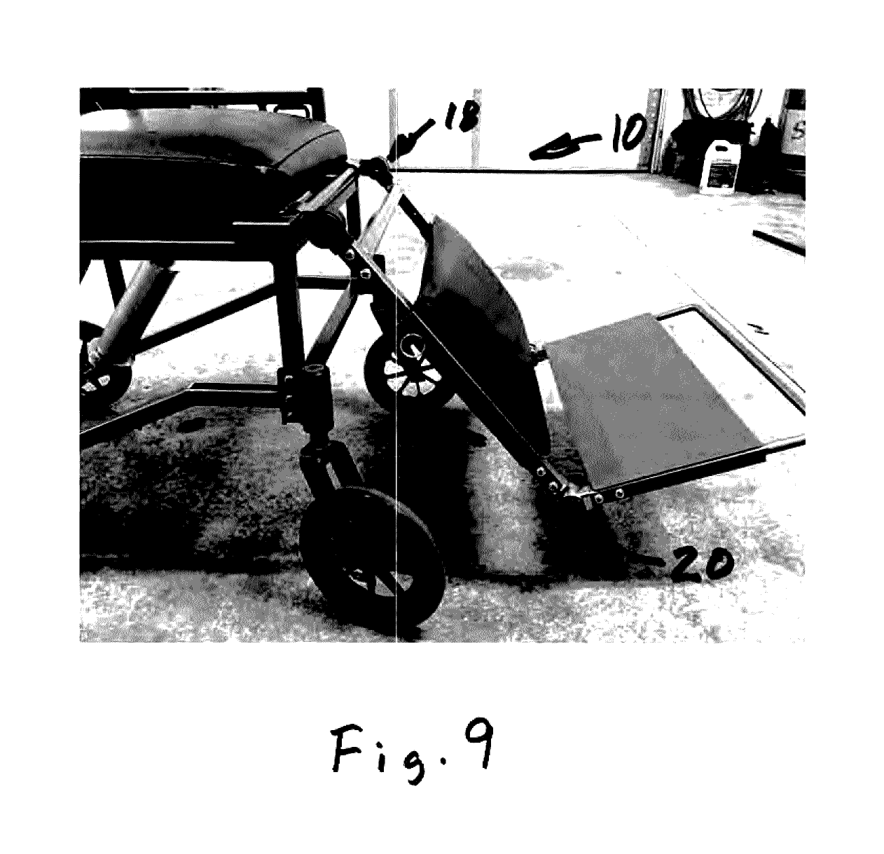

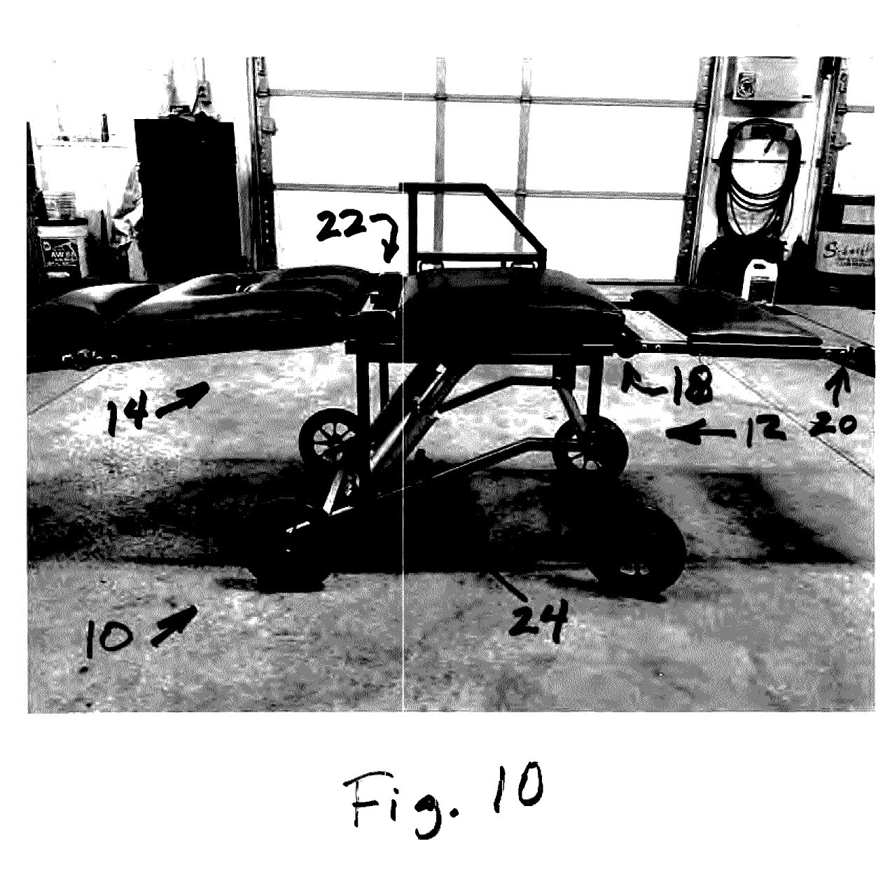

Now, additionally referring to FIG. 9 there is illustrated a lower part of chair 14 with hinge assemblies 18 and 20, which will be discussed later. In FIG. 10 a broader side view of wheelchair 10 is shown with chair 14 in a fully reclined condition. Hinge assemblies 18, 20 and 22 have been utilized to position the components of chair 14 in a substantially horizontal condition. Cylinders 24 can also be seen, which may be water cylinders 24 and are coupled to a pivotal component beneath the seat.

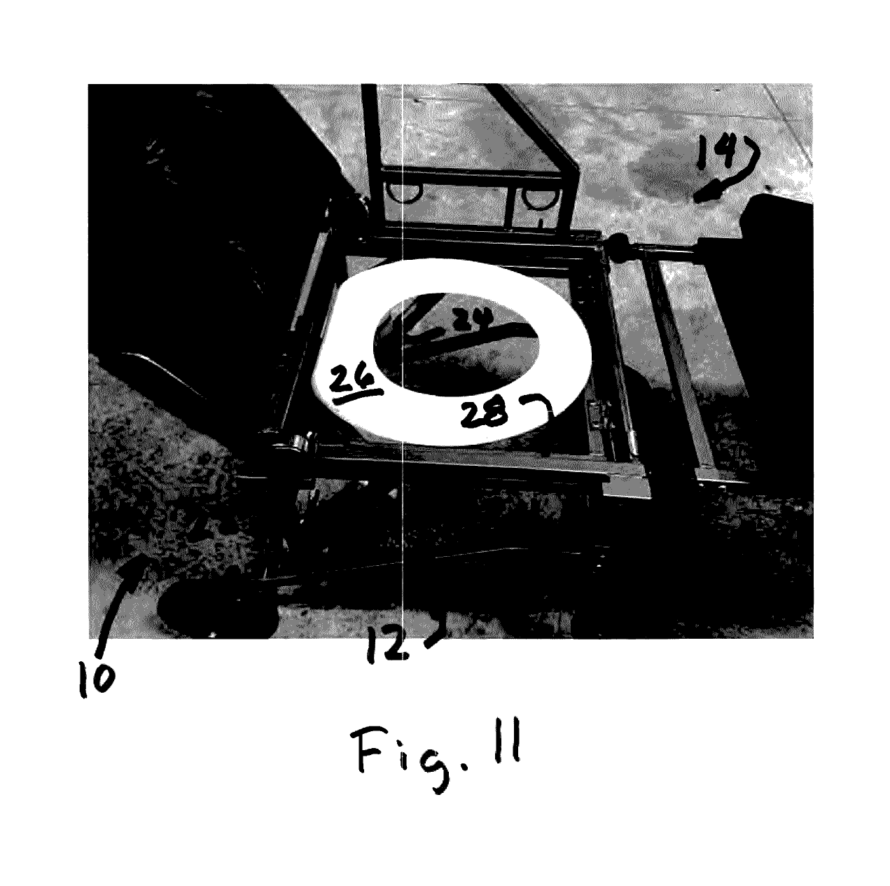

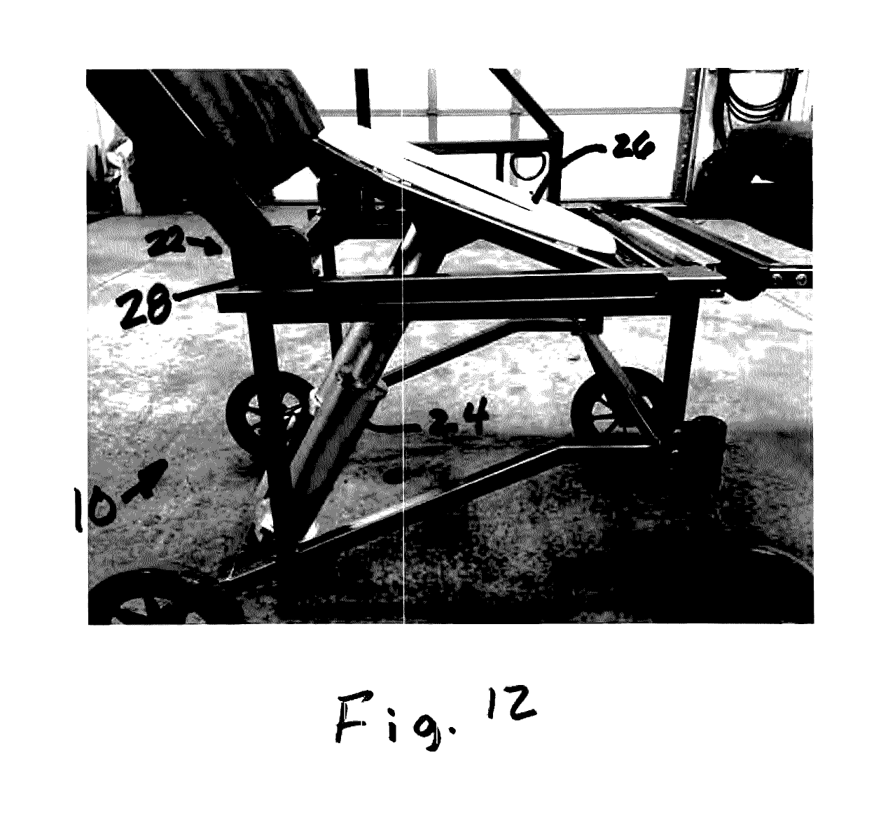

Now, additionally referring to FIGS. 11 and 12 there is shown another aspect of wheelchair 10 with the seat cushion removed, seat 26 is shown with pivotal component 28, to which cylinders 24 are connected. In FIG. 12 seat 26 is shown inclined by way of the extension of cylinders 24 as pivotal member 28, which supports seat 26, is pivoted up and forward.

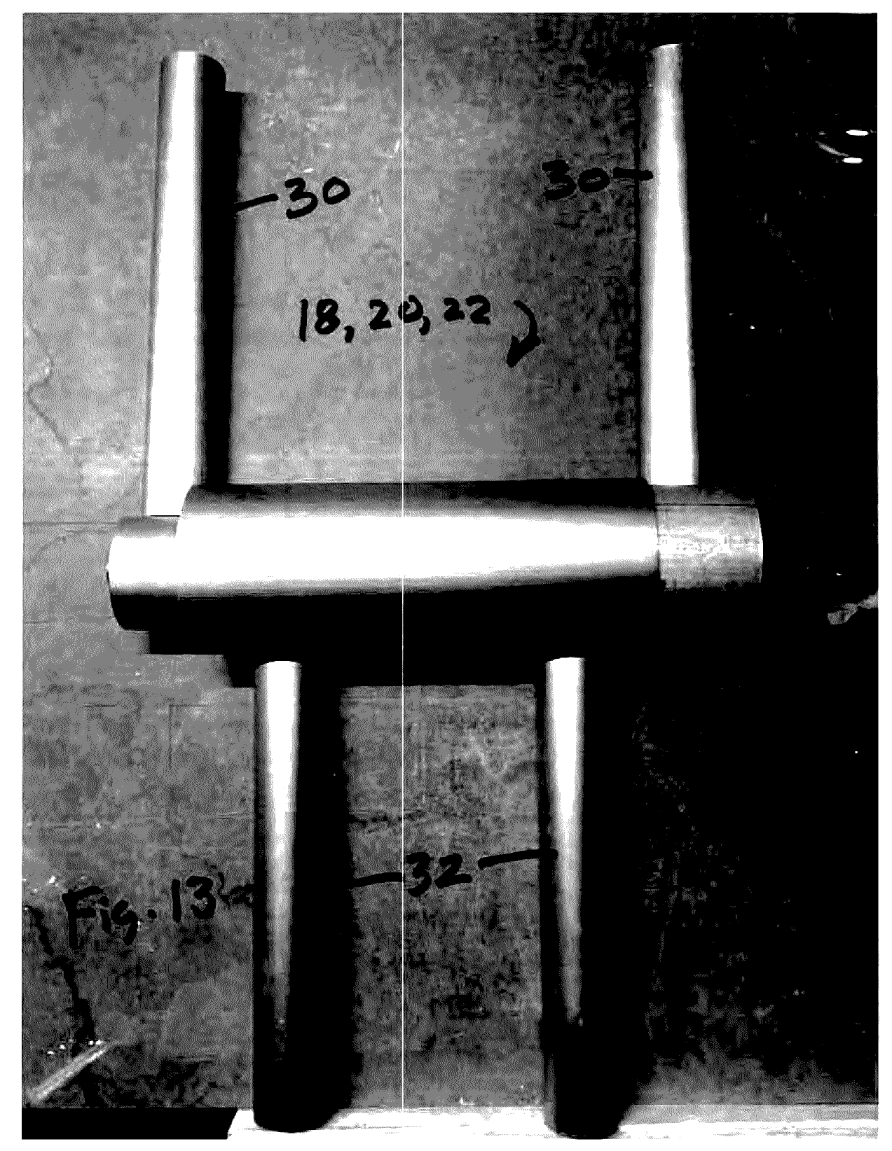

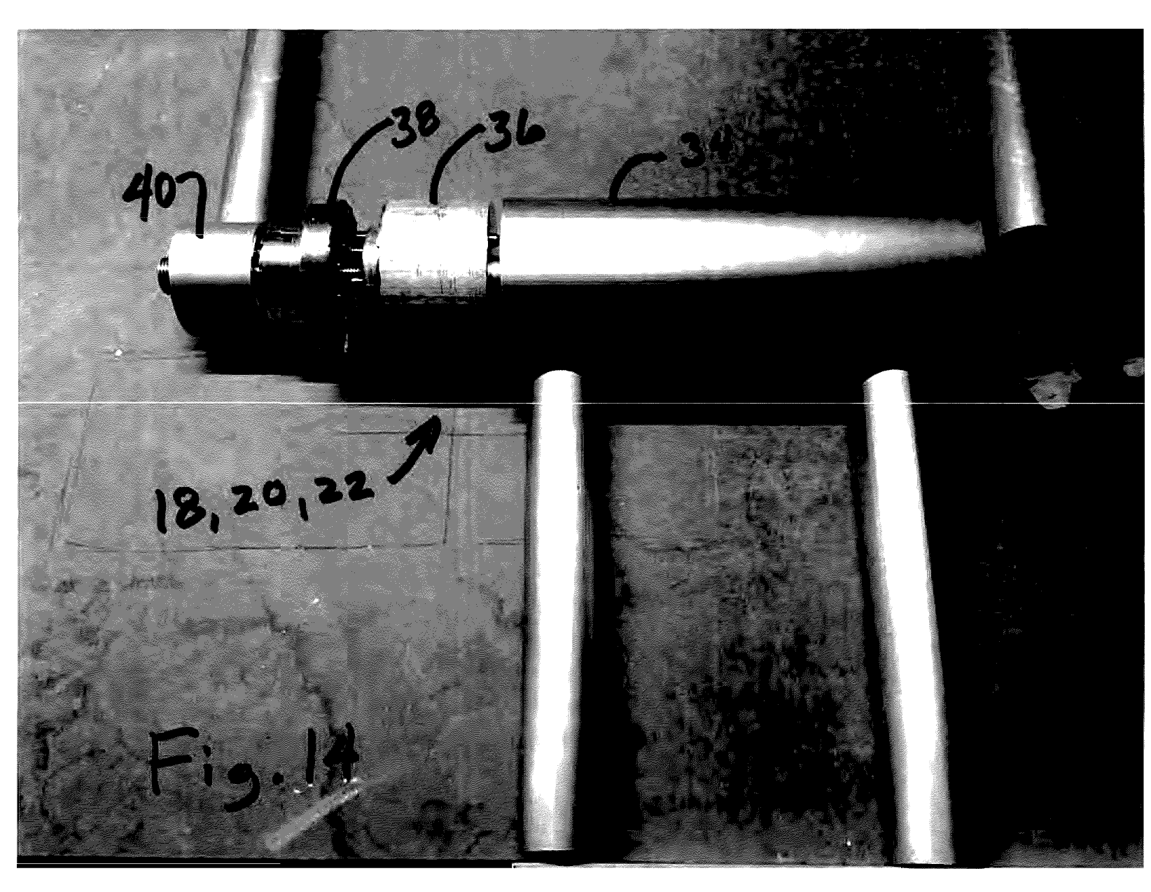

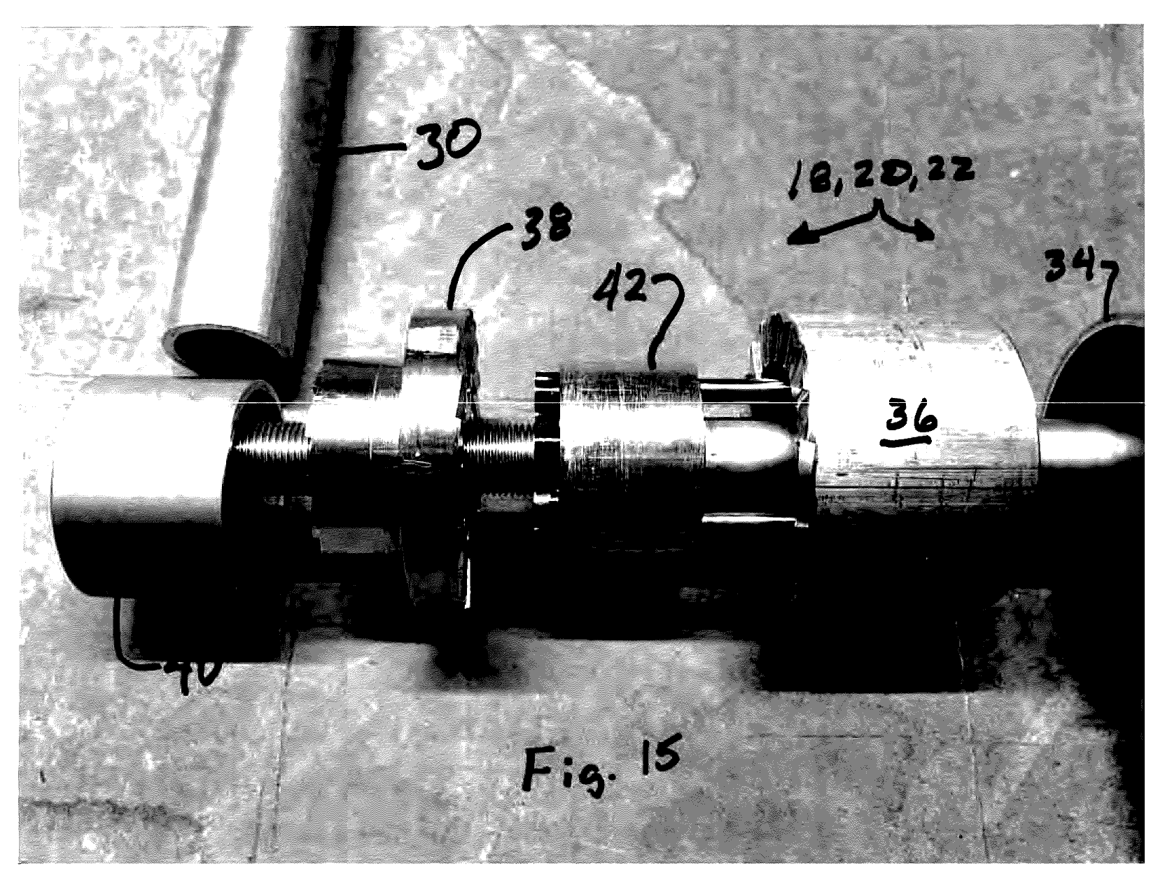

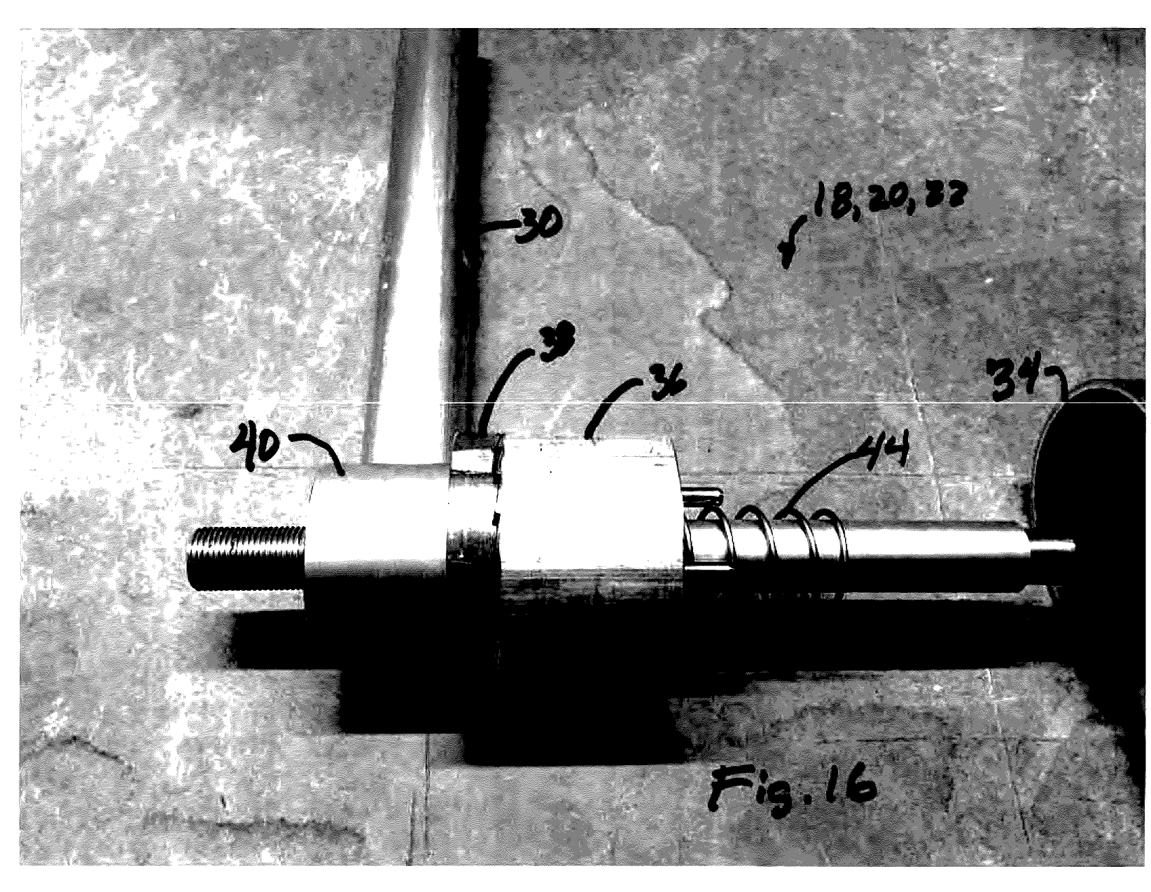

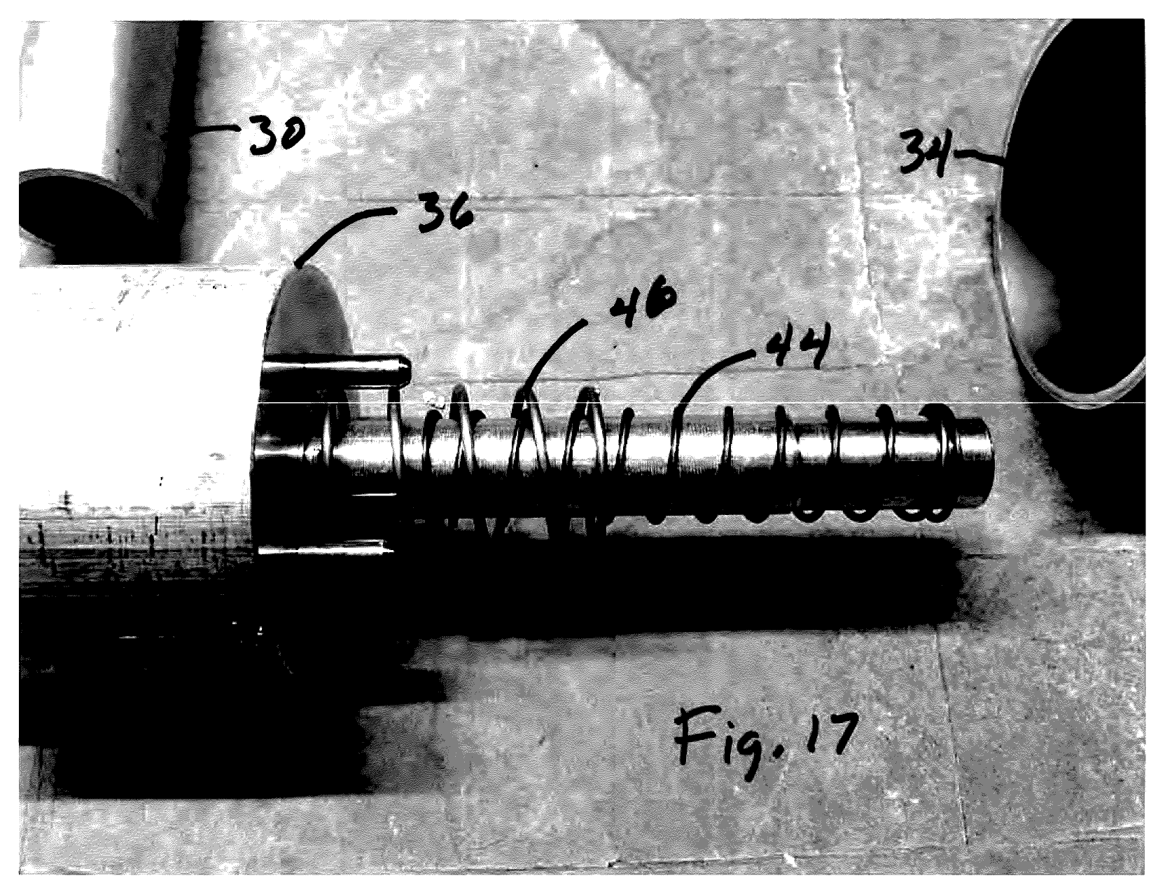

Now, additionally referring to FIGS. 13-17 there is illustrated details of hinge assemblies 18, 20 and 22. Hinge assemblies 18, 20 and 22 are coupled to hinged members 30 and 32 that extend therefrom and can be thought of as the seat and back; the seat and leg section; or the leg section and foot section, all of which are hinged by the applicable hinge assembly. Hinged member 30 is connected to collar 40 and hinged members 32 are coupled to housing 34.

With respect to the operation of hinges 18, 20 and 22, have components 36, 38 and 42 collectively provide a ratchet mechanism, allowing incline steps of 10-15 degree increments with a release past 90 degrees and a fixed reference point at 180 degrees. Spring dampening on the decline and spring assist on the incline is provided by spring 46. The seat back will recline when brought passed 90 degrees vertical. The dampened effect absorbs the weight against the seat back while declining to a fixed point at 180 degrees. Then, by releasing the lock 42 the seat back can ratchet up in 10-15 degree increments with the assistance of an adjustable pretension coil spring 44. The seat can be locked in the fixed position by releasing the actuator (not shown) causing the locking mechanism 42 to engage at that point.

The hinge 18, 20, 22 is composed of a bolt on cylinder housing 34, a cog gear ratchet clutch 36/38, a double throw actuator (not shown), a spring style dampener 46 and a coil spring adjustable tensioner 44. Hinge 18, 20, 22 may be a single pack design or a double pack design with reference to right and left coil clutch packs. Hinge assemblies 18 and 20 are a smaller version of hinge assembly 22.

The hinges 18, 20 and 22 are remotely actuated by a lever system of either cable or hydraulic origin.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A convertible transport system, comprising:
a seat portion; and
a wheeled portion couplable to the seat portion, the seat portion being reclinable whether or not coupled to the wheeled portion.

2. The transport system of claim 1, further comprising a support couplable to the seat portion and not to the wheeled portion.

3. The transport system of claim 1, wherein the seat portion includes a hinge assembly, the hinge assembly allowing incline steps of 10-15 degree increments of a seat back with a release past 90 degrees and a fixed reference point at 180 degrees, the hinge assembly also including a spring dampening on the decline and spring assist on the incline.
